(19) United States
(12) Patent Application Publication
(10) Pub. No.: US 2007/0141991 A1
(43) Pub. Date: Jun. 21, 2007

(54) Apparatus and method for performing ARQ in multi-hop relay cellular network

(75) Inventors: Sung-Kwon Hong, Seoul (KR); Do-Young Kim, Yongin-si (KR); Seung-Hoon Park, Seoul (KR); Dong-Seek Park, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/640,742

(22) Filed: Dec. 18, 2006

(30) Foreign Application Priority Data
Dec. 16, 2005 (KR) 2005-0124270

(51) Int. Cl. H04B 1/00

(52) U.S. Cl. 455/63.1

(57) ABSTRACT

Provided is an apparatus and method for performing an ARQ operation for a uplink (UL) signal in a multi-hop relay cellular network. Upon receipt of a UL signal from a mobile station (MS), it is determined if there is an error in the received UL signal. If there is an error in the received UL signal, the channel condition for a relay station (RS) is compared with the channel condition for the MS. If the channel condition for the RS is better than the channel condition for the MS, it is determined if the RS knows the erroneously received UL signal. If the RS knows the erroneously received UL signal, the RS is requested to retransmit the erroneously received UL signal.

### PRIORITY

This application claims priority under 35 U.S.C. § 119 to an application filed in the Korean Intellectual Property Office on Dec. 16, 2005 and allocated Serial No. 2005-124270, the content of which is incorporated herein by reference.

### BACKGROUND OF THE INVENTION

1. Field of the Invention

The present invention relates generally to a multi-hop relay cellular network, and in particular, to an apparatus and method for performing an automatic repeat request (ARQ) in a multi-hop relay cellular network by using a relay station (RS).

2. Description of the Related Art

Extensive research is being conducted to provide various Quality of Service (QoS) features with a data rate of about 100 Mbps in the advanced fourth-generation (4G) communication system. The 4G communication system is evolving to provide mobility, high data rate transmission, and high QoS in a broadband wireless access (BWA) system such as a Local Area Network (LAN) system and a Metropolitan Area Network (MAN) system. Typical examples of the above system are identified in the Institute of Electrical and Electronics Engineers (IEEE) 802.16d system and the IEEE 802.16e system standards.

The IEEE 802.16d system and the IEEE 802.16e system use an Orthogonal Frequency Division Multiplexing (OFDM)/Orthogonal Frequency Division Multiple Access (OFDMA) scheme for supporting broadband transmission network in a physical channel of the MAN system. The IEEE 802.16d system considers only a fixed Subscriber Station (SS) and a single cell structure (i.e., the mobility of an SS is not considered). The IEEE 802.16e system considers the mobility of an SS. When the mobility of an SS is considered, the SS will be referred to as a mobile subscriber station (MSS).

Because signaling communication between a stationary BS and an MSS is performed through a direct link, the IEEE 802.16e system can easily provide a highly reliable wireless link between the BS and the MSS. However, because the BS is stationary, the IEEE 802.16e system has a low flexibility in constructing a wireless network. Accordingly, the use of the IEEE 802.16e system makes it difficult to provide an efficient communication service in a radio environment where traffic distribution or call requirements change frequently.

In order to overcome this problem, Relay Stations (RSs) can be used to apply a multi-hop relay data transmission scheme to a general cellular communication system such as the IEEE 802.16e system. The use of the multi-hop relay wireless communication system makes it possible to reconfigure a network in rapid response to a change in the communication environment and to operate the entire wireless network more efficiently. A stationary RS, a mobile RS, or a general MSS may be used as an RS in the multi-hop relay scheme.

The introduction of the multi-hop relay scheme into the cellular network is to cover a shadow region with low electric field strength or to reduce initial system costs by installing RSs in initial conditions with low service requirements. The multi-hop relay scheme can expand a cell coverage area and increase a system capacity.

FIG. 1 is a block diagram of a general multi-hop relay cellular network.

Referring to FIG. 1, a mobile station (MS) 110, which is located inside a coverage area 101 of a base station (BS) 100, communicates directly with the BS 100. An MS 120, which is located outside the coverage area 101 and thus has poor channel conditions, communicates indirectly with BS 100 through a relay station (RS) 130.

When MS 120 is located outside BS coverage area 101 or in a shadow zone with a serious shielding effect due to buildings and thus has a poor channel condition, BS 100 can provide an excellent wireless channel to MS 120 by using RS 130. Accordingly, using the multi-hop relay scheme, BS 100 can provide a high-rate data channel to a cell boundary region with a poor channel condition and can expand the cell coverage area. There are a BS-MS link, a BS-RS link and an RS-MS link in the multi-hop relay cellular network.

In addition, the multi-hop relay cellular network may use a cooperation scheme where the MS can function as an RS without any discrimination there between. When the multi-hop relay cellular network uses the cooperation scheme, an MS broadcasts a TX signal to a BS and a second MS. An MS having received a TX signal from another MS decodes the received signal to detect the destination thereof. Thereafter, the MS retransmits the signal to a BS or another MS depending on the detected destination. Accordingly, the use of the cooperation scheme makes it possible to use the link environment between a BS and another MS and to achieve the diversity effect.

As described above, the use of the multi-hop relay wireless communication network makes it possible to reconstruct a network in rapid response to a change in the communication environment and to operate the entire wireless network more efficiently. However, because wireless channels between the BS, the MS and the RS are used to perform a communication in the multi-hop relay cellular network, signals communicated between the BS, the MS and the RS may be distorted. What is therefore required is a method for increasing the reliability of signals communicated between the BS, the MS and the RS in the multi-hop relay cellular network.

### SUMMARY OF THE INVENTION

An object of the present invention is to substantially solve at least the above problems and/or disadvantages and to provide at least the advantages below. Accordingly, an object of the present invention is to provide an apparatus and method for increasing the reliability of signals communicated in an ARQ scheme in a multi-hop relay cellular network.

Another object of the present invention is to provide an apparatus and method for performing an ARQ in accordance with channel conditions between a BS, an RS, and an MS in a multi-hop relay cellular network.

According to one aspect of the present invention, a method for performing an ARQ operation of a BS in a multi-hop relay cellular network, includes: upon receipt of an up-link (UL) signal from an MS, determining if there is error in the received UL signal; if there is an error in the received UL signal, comparing the channel condition for a RS and the channel condition for the MS; if the channel condition for the RS is better than the channel condition for the MS, determining if the RS knows of the erroneously-received UL signal; and if the RS knows of the erroneously-received UL signal, requesting the RS to retransmit the erroneously-received UL signal.

According to another aspect of the present invention, a method for performing an ARQ operation of an RS in a multi-hop relay cellular network, includes: upon receipt of a UL signal from an MS, determining if there is error in the received UL signal; if there is no error in the received UL signal, transmitting an ACK response message to the MS and a BS; and if a retransmission request signal is received from the BS, selecting a retransmission signal according to the request and transmitting the selected retransmission signal to the BS.

According to still another aspect of the present invention, a method for performing an ARQ operation of an MS in a multi-hop relay cellular network, includes: after transmission of a UL signal to a BS and an RS, determining if a response signal for the UL signal is received; if a NACK response signal is received from the BS, determining if a retransmission request signal for the UL signal is received from the BS; and if the retransmission request signal is received, selecting a retransmission signal according to the retransmission request signal and transmitting the selected retransmission signal to the BS.

According to yet another aspect of the present invention, a method for performing an ARQ operation of a BS in a multi-hop relay cellular network, includes: after transmission of a down-link (DL) signal to an MS and an RS, determining if a response message is received from the MS and the RS that has received the DL signal; if the received response message is a NACK response message, comparing the channel condition of a link between the RS and the MS with the channel condition of a link between the BS and the MS; if the link between the RS and the MS is better in channel condition than the link between the BS and the MS, determining if the RS knows the erroneously-received DL signal; and if the RS knows the erroneously-received DL signal, requesting the RS to retransmit the erroneously-received DL signal to the MS.

According to yet another aspect of the present invention, a method for performing an ARQ operation of an RS in a multi-hop relay cellular network, includes: upon receipt of a DL signal from a BS, determining if there is error in the received DL signal; if there is no error in the received DL signal, transmitting an ACK response message to the BS and the MS; and if a retransmission request signal is received from the BS, retransmitting a retransmission signal corresponding to the request to the MS.

According to a further aspect of the present invention, a BS transmitter for performing an ARQ operation in a multi-hop relay cellular network, includes: a retransmission selector for detecting the channel conditions of an RS, an MS and a BS to select a subject that is to retransmit a signal; and an ARQ controller for determining a coding rate, a modulation scheme and a frame size of the retransmission signal.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a general multi-hop relay cellular network;

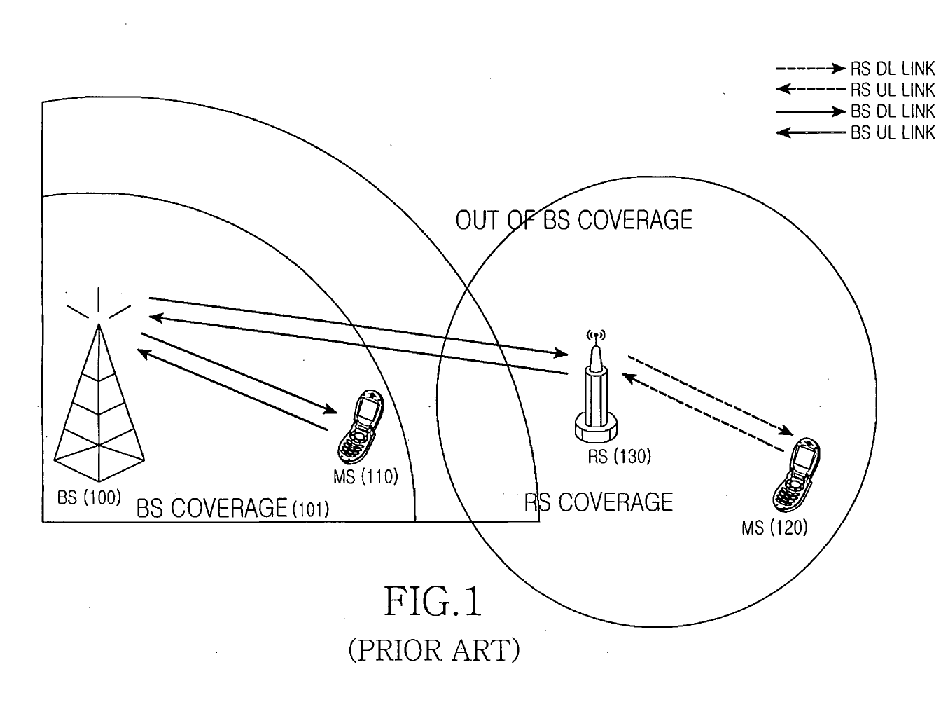

FIG. 2 is a diagram illustrating a flow of an UL signal in a multi-hop relay cellular network according to the present invention;

FIG. 3 is a diagram illustrating a flow of a response signal for an UL signal in a multi-hop relay cellular network according to the present invention;

FIGS. 4A to 4C are diagrams illustrating retransmission of an UL signal in a multi-hop relay cellular network according to the present invention;

FIG. 5 is a flowchart showing an operational procedure of a BS in accordance with the retransmission of an UL signal in a multi-hop relay cellular network according to the present invention;

FIG. 6 is a flowchart showing an operational procedure of an MS in accordance with the retransmission of an UL signal in a multi-hop relay cellular network according to the present invention;

FIG. 7 is a flowchart showing an operational procedure of an MS in accordance with the retransmission of an UL signal in a multi-hop relay cellular network according to the present invention;

FIG. 8 is a diagram illustrating a flow of a DL signal in a multi-hop relay cellular network according to the present invention;

FIG. 9 is a diagram illustrating a flow of a response signal for a DL signal in a multi-hop relay cellular network according to the present invention;

FIGS. 10A and 10B are diagrams illustrating retransmission of a DL signal in a multi-hop relay cellular network according to the present invention;

FIG. 11 is a flowchart illustrating an operational procedure of a BS in accordance with the retransmission of a DL signal in a multi-hop relay cellular network according to the present invention;

FIG. 12 is a flowchart illustrating an operational procedure of an MS in accordance with the retransmission of a DL signal in a multi-hop relay cellular network according to the present invention;

FIG. 13 is a diagram illustrating a flow of an UL signal in a multi-hop relay cellular network according to the present invention;

FIG. 14 is a diagram illustrating a flow of a response signal for an UL signal in a multi-hop relay cellular network according to the present invention;

FIGS. 15A and 15B are diagrams illustrating retransmission of an UL signal in a multi-hop relay cellular network according to the present invention;

FIG. 16 is a block diagram of a BS transmitter for signal retransmission in a multi-hop relay cellular network according to the present invention; and

FIG. 17 is a block diagram of an RS transmitter for signal retransmission in a multi-hop relay cellular network according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and method for performing ARQ in a multi-hop relay cellular network by using an RS.

Although an OFDMA wireless communication system will be taken as an example in the following description, the present invention can be similarly applied to other multiple access schemes.

The use of an ARQ scheme in the multi-hop relay cellular network will be described in terms of an uplink (UL) signal of an MS and in terms of a downlink (DL) signal of a BS.

The use of the ARQ scheme for the UL signal will be described first. The following description is made on the assumption that an MS is used instead of a separate RS.

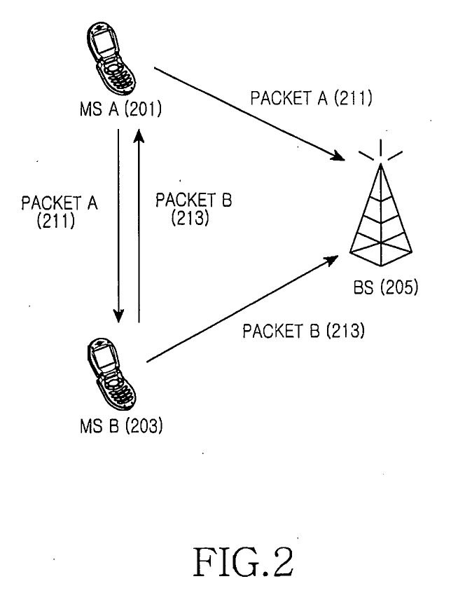

Referring to FIG. 2, a mobile station (MS) A 201 transmits uplink (UL) signals to an MS B 203 and a base station (BS) 205 (step 211). Likewise, MS B 203 transmits UL signals to MS A 201 and BS 205 (step 213).

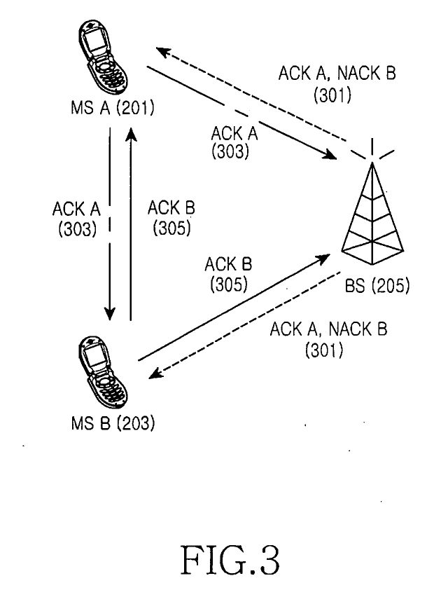

Thereafter, BS 205 and MSs 201 and 230 transmit a response signal for the UL signal as illustrated in FIG. 3. An ACK response signal is transmitted if the UL signal is decoded as “errorless”, while a NACK response signal is transmitted if the UL signal is decoded as “erroneous”.

Referring to FIG. 3, upon receipt of the UL signal, BS 205 and MSs 201 and 203 determine if there is an error in the received UL signal. Thereafter, BS 205 and MSs 201 and 203 transmit a response signal for the received UL signal in accordance with the determination results.

For example, upon receiving the UL signals from MSs 201 and 203 as illustrated in FIG. 2, BS 205 determines if there is an error in the received UL signals. If the UL signal of MS A 201 is decoded as “errorless” and if the UL signal of MS B 20e is decoded as “erroneous”, BS 205 transmits an ACK response signal and a NACK response signal to MS A 201 and MS B 203, respectively (step 301).

If the UL signal of MS B 203 is decoded as “errorless”, MS A 201 transmits an ACK response signal to MS B 203 and BS 205 (step 303).

Likewise, if the UL signal of MS A 201 is decoded as “errorless”, MS B 203 transmits an ACK response signal to MS A 201 and BS 205 (step 305).

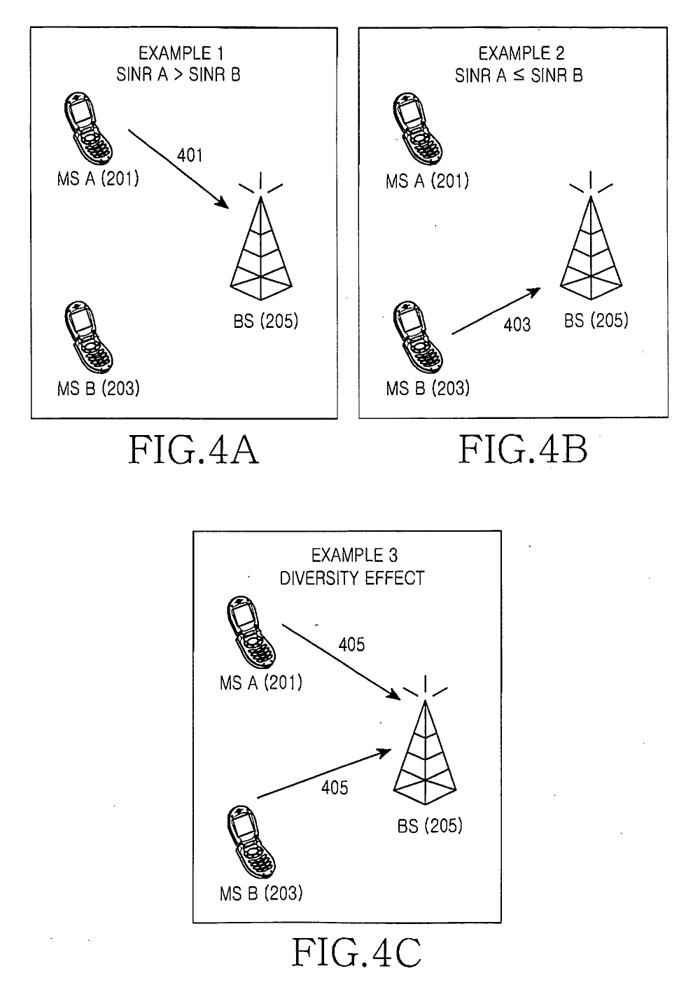

If there is error in the UL signal that BS 205 receives from MS B 203, BS 205 transmits a NACK response signal to MS A 201 and MS B 203 to request retransmission of the UL signal. Hereinafter, if there is an error in a received signal, the received signal will be referred to as “the erroneously-received signal”. As illustrated in FIG. 4, BS 205 detects channel condition information of MS A 201 and MS B 203, selects the MS with a good channel condition, and requests the selected MS to retransmit the erroneously received UL signal. An example of the channel condition information is a signal-to-interference plus noise ratio (SINR). The channel condition information measured by MS A 201 and e MS B 203 may be transmitted over an UL channel to BS 205.

The following description assumes that MS A 201 has errorlessly received the UL signal of MS B 203.

Referring to FIGS. 4A to 4C, if there is an error in the UL signal received from MS B 203, BS 205 compares the SINRs of MS A 201 and MS B 203 to select the MS with a better channel condition. Thereafter, BS 205 requests the selected MS to retransmit the erroneously received UL signal. At this point, MS A 201 functions as a relay station (RS).

That is, if SINR A of MS A 201 is greater than SINR B of MS B 203 (SINR A>SINR B), BS 205 requests MS A 201 to retransmit the erroneously-received UL signal, as illustrated in FIG. 4A. In response to the retransmission request of BS 205, MS A 201 retransmits the UL signal received from MS B 203 to BS 205 (step 401). At this point, the SINR of MS A 201 refers to an SINR of a link between MS A 201 and BS 205 and the SINR of MS B 203 refers to an SINR of a link between MS B 203 and BS 205.

If the SINR A of MS A 201 is less than or equal to the SINR B of MS B 203 (SINR A<SINR B), BS 205 requests MS B 203 to retransmit the erroneously-received UL signal, as illustrated in FIG. 4B. In response to the retransmission request of BS 205, MS B 203 retransmits the requested UL signal to BS 205 (step 403).

In addition, in order to increase the reliability of a receive (RX) signal or to provide a good link performance, BS 205 request MS A 201 and MS B 203 to retransmit the erroneously-received UL signal, as illustrated in FIG. 4C. In response to the retransmission request of BS 205, MS A 201 and MS B 203 retransmit the requested UL signal to BS 205 (step 403). Accordingly, BS 205 can obtain a diversity effect for an RX signal.

As described above, if the channel conditions between MSs 201 and 203 in the cellular network are good and thus MSs 201 and 203 can errorlessly receive a UL signal from another MS, BS 205 compares the channel conditions of MSs 201 and 203. BS 205 selects the MS with a better channel condition and requests the selected MS to retransmit the erroneously received UL signal. On the other hand, if the channel conditions of MSs 201 and 203 in the cellular network are poor and thus MSs 201 and 203 cannot receive a UL signal from another MS, BS 205 makes a retransmission request for the erroneously received UL signal in consideration of each of MSs 201 and 203. If MS A 201 can receive a UL signal of MS B 203 and if MS B 203 cannot receive a UL signal of MS A 201, BS 205 makes a retransmission request for the UL signal received from MS B 203 in consideration of the channel conditions, as illustrated in FIGS. 4A to 4C. On the contrary, BS 205 makes a retransmission request for the UL signal received from MS A 201 in consideration of each of MSs 201 and 203.

The operational procedures of MS A 201, MS B 203 and BS 205 for retransmission of the erroneously-received UL signal, as illustrated in FIG. 3, will now be described in detail. At this point, the MS can function as an RS. That is, the following description will be made on the assumption that an MS, which can errorlessly receive a UL signal from another MS, functions as an RS. At this point, the BS errorlessly receives the UL signal of the MS functioning as an RS. For example, because MS A 201 errorlessly receives the UL signal of MS B 203 and BS 205 errorlessly receives the UL signal of MS A 201, the following description will be made on the assumption that MS A 201 functions as an RS.

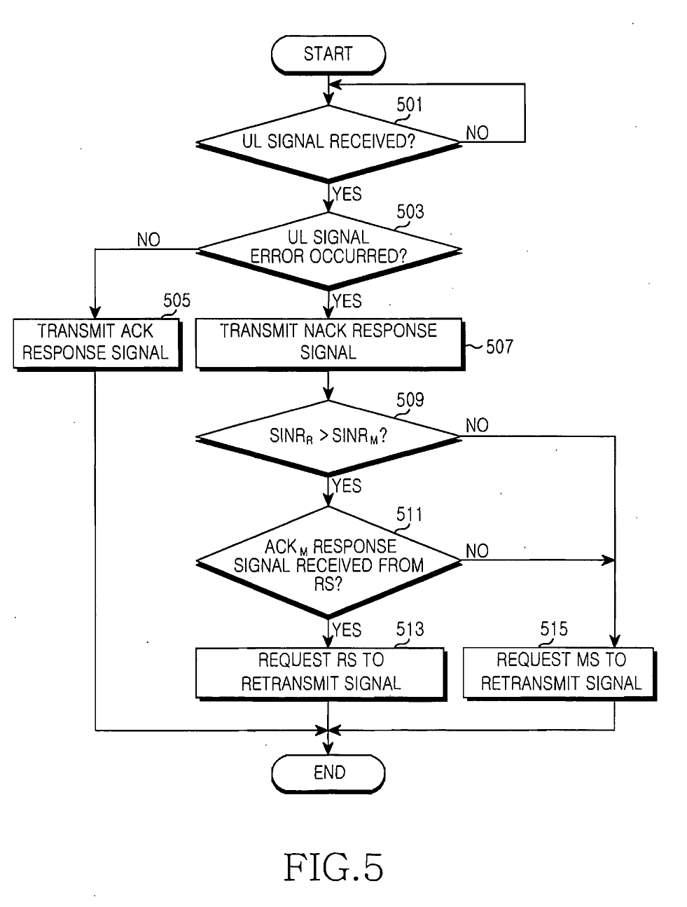

Referring to FIG. 5, the BS determines in step 501 if UL signals are received from MSs, for example, MS A 201 and MS B 203 as illustrated in FIG. 2.

Upon receipt of the UL signals, the BS determines in step 503 if there is an error in the received UL signal.

If there is no error in the received UL signal, the BS transmits an ACK response signal to the MSs in step 505. For example, as illustrated in FIG. 3, if the UL signal of MS A 201 is decoded as “errorless”, BS 205 transmits an ACK response signal to MS A 201 and MS B 203. Thereafter, the procedure is ended.

On the other hand, if there is an error in the received UL signal, the BS transmits a NACK response signal to the MSs in step 507. For example, as illustrated in FIG. 3, if the UL signal of MS B 203 is decoded as “erroneous”, the BS transmits a NACK response signal to MS B 203 and MS A 201. Hereinafter, the MS, which has errorlessly transmitted the UL signal, is referred to as “an RS”.

Thereafter, in step 509, the BS compares the SINRs of the RS and the MS to select the MS that needs to retransmit the erroneously received UL signal. At this point, the BS receives SINR information from the RS and the MS over a UL channel.

If the SINR of the RS is less than of equal to the SINR of the MS (SINR_{R}≦SINR_{M}), the BS requests in step 515 the MS to retransmit the erroneously received UL signal. For example, as illustrated in FIG. 4B, BS 205 requests the MS B 203 to retransmit the erroneously received UL signal. Thereafter, the procedure is ended.

On the other hand, if the SINR of the RS is greater than the SINR of the MS (SINR_{R}>SINR_{M}), the BS determines in step 511 if the RS has errorlessly received the UL signal of the MS. That is, the BS detects a response signal for the received signal that the RS transmits after receipt of a signal from the MS. For example, as illustrated in FIG. 3, BS 205 determines if a response signal is received in response to the UL signal that MS A 201 has transmitted after receipt of the UL signal from MS B 203.

If the RS fails to receive the UL signal of the MS, that is, if a NACK response signal is received from the RS, the BS requests in step 515 the MS to retransmit the erroneously received UL signal. For example, as illustrated in FIG. 4B, BS 205 requests MS B 203 to retransmit the erroneously received UL signal.

If the RS has errorlessly received the UL signal of the MS, that is, if an ACK signal is received from the RS, the BS requests in step 513 the RS to retransmit the erroneously received UL signal of the MS. For example, as illustrated in FIG. 4A, BS 205 requests MS A 201 to retransmit the erroneously received UL signal of MS B 203. Thereafter, the procedure is ended.

The following description will be made on the assumption that the RS is MS A 201 in FIGS. 2, 3 and 4A to 4C.

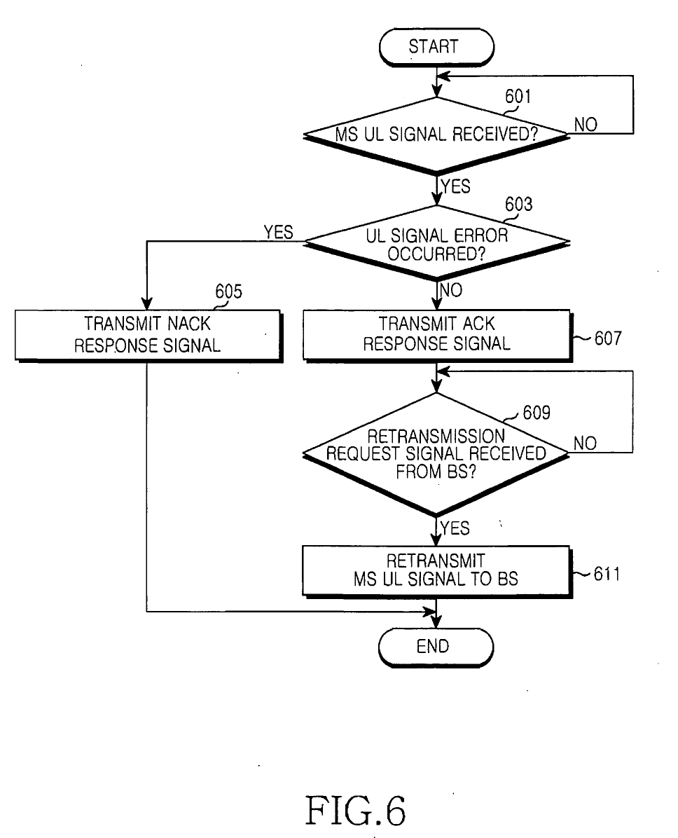

Referring to FIG. 6, the RS determines in step 601 if a UL signal is received from an MS. For example, as illustrated in FIG. 2, MS A 201 determines if a UL signal is received from MS B 203.

If the UL signal of the MS is received, the RS decodes the received UL signal and determines if there is an error in the received UL signal, in step 603. For example, as illustrated in FIG. 2, MS A 201 determines if the received UL signal of MS B 203 is decoded as “errorless”.

If there is an error in the received UL signal, the RS transmits a NACK response signal to the MS and the BS in step 605.

On the other hand, if there is no error in the received UL signal, the RS transmits an ACK response signal to the MS and the BS. For example, as illustrated in FIG. 3, if the received UL signal of MS B 203 is decoded as “errorless”, MS A 201 transmits an ACK response signal to MS B 203 and BS 205.

Thereafter, in step 609, the RS determines if a retransmission request signal for the UL signal is received from the BS.

If the retransmission request signal is received, the RS retransmits in step 611 a signal received from the MS to the BS. For example, as illustrated in FIG. 4A, MS A 201 retransmits a signal received from MS B 203 to BS 205. Thereafter, the procedure is ended.

The following description will be made on the assumption that the MS is MS B 203 in FIGS. 2, 3 and 4.

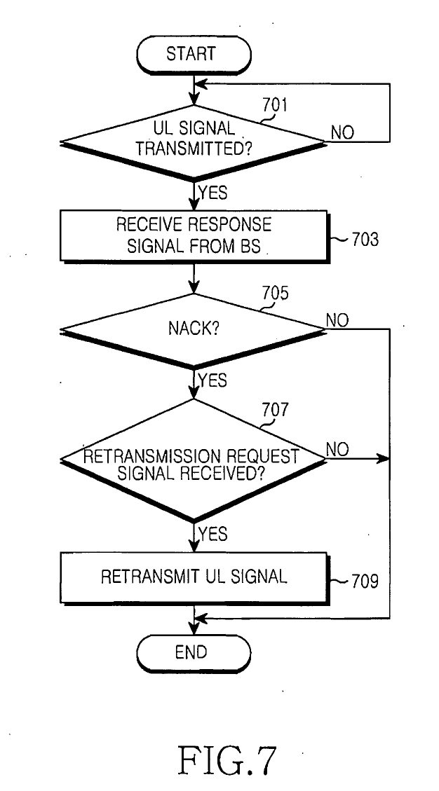

Referring to FIG. 7, the MS transmits UL signals to the RS and the BS in step 701. For example, as illustrated in FIG. 2, MS B 203 transmits a UL signal to MS A 201 and BS 205.

In step 703, the MS receives a corresponding response signal form the BS. In step 705, the MS detects the received response signal.

If the received response signal is an ACK response signal, that is, if the BS has errorlessly received the UL signal, the procedure is ended.

On the other hand, if the received response signal is a NACK response signal, that is, if the BS has erroneously received the UL signal, the MS determines in step 707 if a retransmission request signal for the erroneously received UL signal is received from the BS.

If the retransmission request signal is received from the BS, the MS retransmits the erroneously received UL signal to BS in step 709. For example, as illustrated in FIG. 4B, MS B 203 retransmits the erroneously received UL signal to BS 205. Thereafter, the procedure is ended.

An ARQ operation for a downlink (DL) signal will now be described in detail. The following description will be made on the assumption that an MS is used instead of a separate RS.

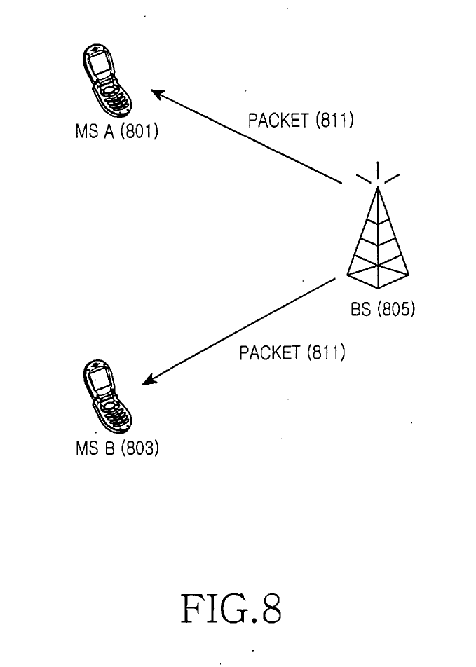

Referring to FIG. 8, a BS 805 transmits DL signals to an MS A 801 and an MS B 803 in step 811. At this point, the DL signal for MS A 801 contains the DL signal for MS B 803 and vice versa.

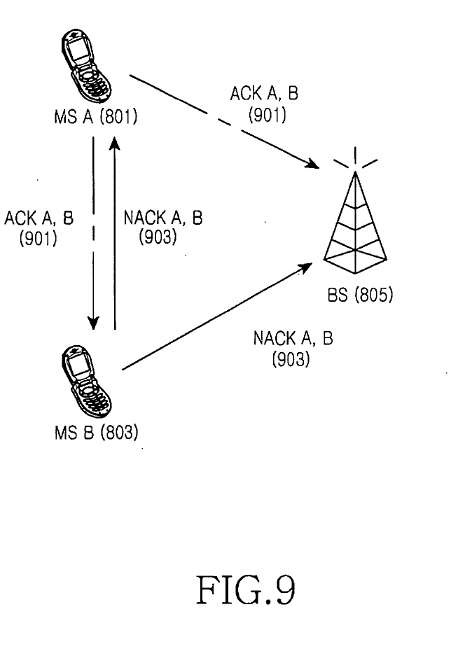

Thereafter, as illustrated in FIG. 9, MSs 801 and 803 transmit response signals for the received DL signals. At this point, if the received DL signal of BS 205 is decoded as “errorless”, an ACK response signal is transmitted from the MS to the BS. On the other hand, if the received DL signal of BS 205 is decoded as “erroneous”, a NACK response signal is transmitted from the MS to the BS.

Referring to FIG. 9, if MS A 801 and MS B 803 receive a DL signal from BS 805, MS A 801 and MS B 803 determine if there is an error in the received DL signal. Thereafter, MS A 801 and MS B 803 transmits a response signal for the received UL signal. For example, as illustrated in FIG. 8, if MS A 801 and MS B 803 receive a signal from BS 805, MS A 801 and MS B 803 determine if there is an error in the received signal.

If the DL signal of BS 805 is received errorlessly, MS A 801 transmits an ACK response signal to MS B 803 and BS 805 (step 901).

On the other hand, if there is an error in the received DL signal of BS 805, MS B 803 transmits a NACK response signal to BS 805 and MS A 801 (step 903).

As described above, if there is an error in the DL signal that MS B 803 receives from BS 805, MS B 803 transmits a NACK response signal to BS 805 to request retransmission of the DL signal.

Upon receipt of the retransmission request from MS B 803, BS 805 compares the channel condition information (e.g., SINR) of MS A 801 and BS 805. Thereafter, BS 805 performs a control operation such that the DL signal is retransmitted from a node with a good channel condition to MS B 803.

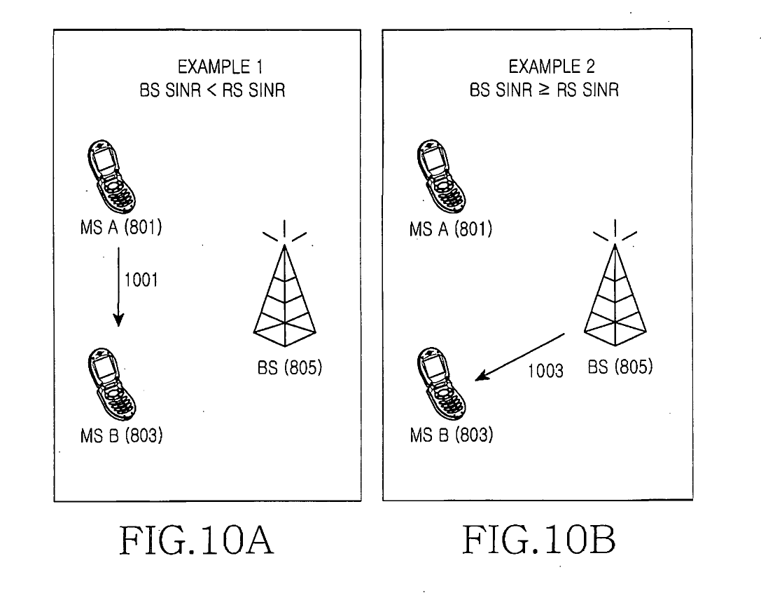

FIGS. 10A and 10B are diagrams illustrating retransmission of a DL signal in a multi-hop relay cellular network according to the present invention. The following description will be made on the assumption that MS A 801 errorlessly receives the DL signal of MS B 803 that is transmitted from BS 805.

Referring to FIGS. 10A and 10B, upon receipt of a NACK response signal from MS B 803, BS 805 compares the SINRs of MS A 801 and BS 805 to select a channel with a better condition. Thereafter, BS 805 performs a control operation such that the erroneously received DL signal is retransmitted to MS B 803 over the selected channel. The SINR of MS A 801 refers to an SINR of a link between MS A 801 and MS B 803, and the SINR of BS 805 refers to an SINR of a link between BS 805 and MS B 803.

That is, if the SINR of MS A 801 is greater than the SINR of BS 805 (RS SINR>BS SINR), BS 805 requests MS A 801 to retransmit the erroneously received DL signal of BS 805 to MS B 803, as illustrated in FIG. 10A. Upon receipt of the retransmission request, MS A 801 retransmits the erroneously received DL signal of BS 805 to MS B 803 (step 1001).

If the SINR of MS A 801 is less than or equal to the SINR of BS 805 (RS SINR≦BS SINR), BS 805 retransmits the erroneously received DL signal to MS B 803, as illustrated in FIG. 10B (step 1003).

As described above, if the channel condition between MSs 801 and 803 and thus a signal can be communicated between MSs 801 and 803, BS 805 determines a subject that is to retransmit an erroneously-received signal, in consideration of the channel condition of MS A 801 and it own channel condition. On the other hand, if the channel condition between MSs 801 and 803 is poor and a signal cannot be communicated between MSs 801 and 803, BS 805 performs the retransmission of the signal in consideration of each of MS A 801 and MS B 803.

The operational procedures of MS A 801, MS B 803 and BS 805 for retransmission of the erroneously-received signal, as illustrated in FIG. 9, will now be described in detail. The MS can function as an RS. That is, the following description will be made on the assumption that an MS, which can errorlessly receive a DL signal from a BS and can errorlessly communicate with another MS, functions as an RS. For example, because MS A 801 can errorlessly receive the DL signal of BS 805 and can errorlessly communicate with MS B 803, the following description will be made on the assumption that MS A 801 functions as an RS.

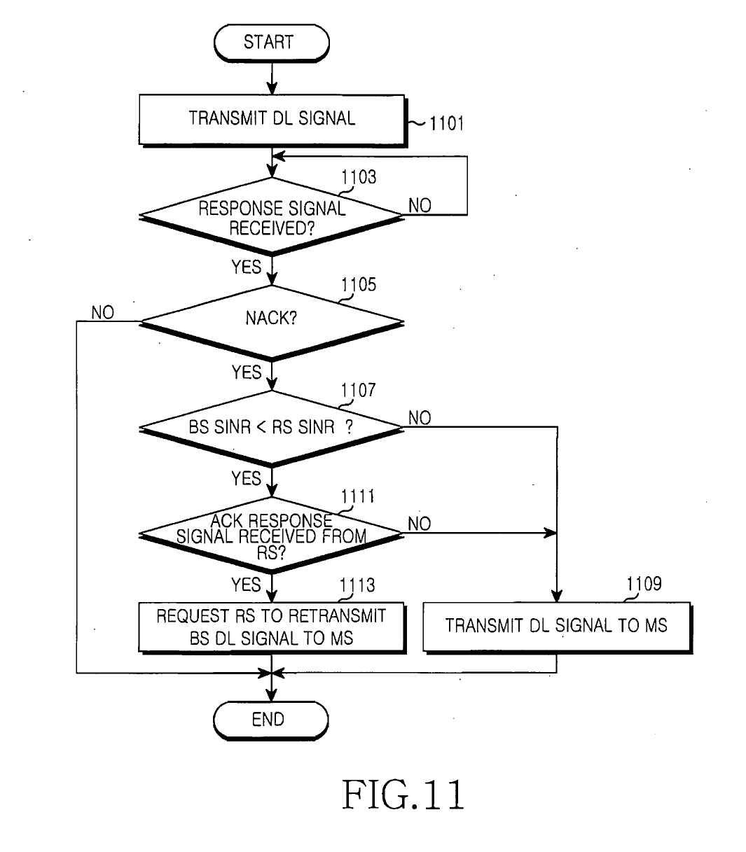

Referring to FIG. 11, the BS transmits DL signals to MSs in step 1101. For example, as illustrated in FIG. 8, BS 805 transmits DL signals to MS A 801 and MS B 803. The DL signal for MS A 801 contains the DL signal for MS B 803 and vice versa.

In step 1103, the BS determines if a response signal is received from the MS that has received the DL signal. For example, as illustrated in FIG. 9, BS 805 determines if a response signal is received from MS A 801 and MS B 803 that has received the DL signal of BS 805.

If the response signal is received, the BS detects the response signal and determines if the MSs have errorlessly received the DL signal, in step 1105. If the response signal is an ACK response signal, that is, if the MSs have errorlessly received the DL signal, the procedure is ended.

On the other hand, if the response signal is a NACK response signal, that is, if there is an error in the DL signal received by the MSs, the BS compares the SINRs of the BS and the RS in step 1107.

If the SINR of the RS is less than or equal to the SINR of the BS (BS SINR≧RS SINR), the BS retransmits the erroneously received DL signal to the MS in step 1109.

On the other hand, if the SINR of the RS is greater than the SINR of the BS (BS SINR≦RS SINR), the BS determines if the RS knows the DL signal information of the BS to be transmitted to the MS, in step 1111. For example, as illustrated in FIG. 8, MS A 801 transmits, to BS 805 and MS B 803, not only a response signal for a DL signal received from BS 805 but also a response signal for a DL signal for MS B 803 contained in the received DL signal. Accordingly, using the response signal received from MS A 801, BS 805 can determine if MS A 801 knows a DL signal for MS B 803.

If the response signal for the MS received from the RS is a NACK response signal, the BS retransmits the erroneously received DL signal to the MS in step 1109.

On the other hand, if the response signal for the MS is an ACK response signal, the BS requests the RS to retransmit the DL signal of the BS in step 1113. Thereafter, the procedure is ended.

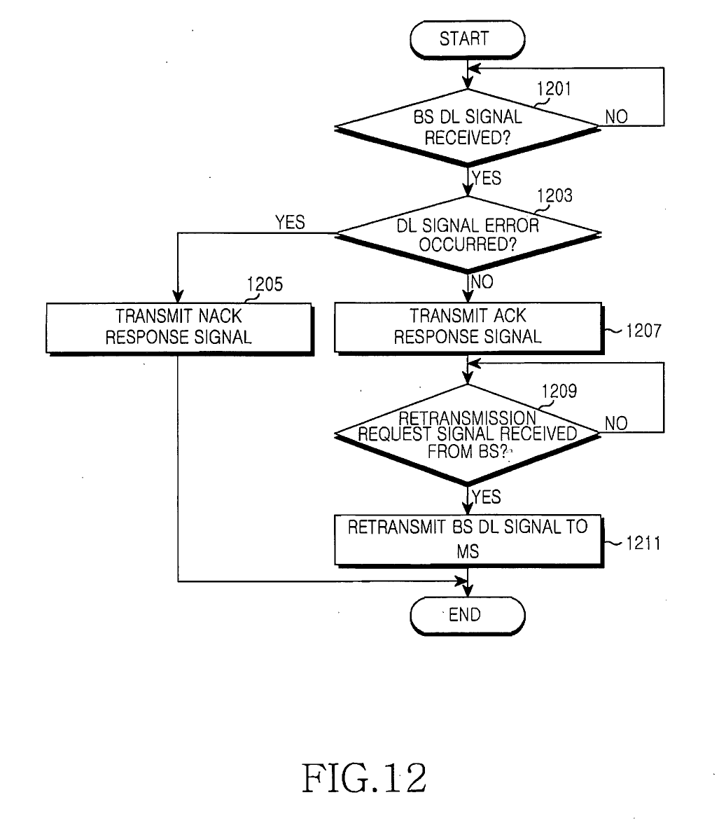

Referring to FIG. 12, the MS determines in step 1201 if a DL signal is received from a BS.

If the DL signal is received from the BS, the MS determines in step 1203 if there is an error in the received DL signal. The DL signal contains a DL signal of another MS. Accordingly, the MS determines if there is an error in a DL signal of another MS as well as its own DL signal. For example, as illustrated in FIG. 8, the DL signal transmitted from BS 805 to the MS A 801 contains information about a DL signal for MS B 803. Accordingly, MS A 801 determines if there is an error in a DL signal for MS B 803 as well as in its own DL signal.

If there is an error in the received DL signal, the MS transmits a NACK response signal to the BS in step 1205. That is, the MS requests the BS to retransmit the erroneously received DL signal.

Thereafter, the erroneously received DL signal is retransmitted from the BS to the MS and the procedure is ended.

On the other hand, if the DL signal is decoded as “errorless”, that is, if there is no error in the DL signal, the MS transmits an ACK response signal to the BS in step 1207.

Thereafter, in step 1209, the MS determines if a retransmission request signal for the DL signal is received from the BS.

If the retransmission request signal is received from the BS, the MS retransmits the erroneously received DL signal of the BS to another MS in step 1211. That is, MS functions as an RS. For example, as illustrated in FIG. 10A, if a retransmission request signal is received from BS 805, MS A 801 retransmits the erroneously received DL signal to MS B 803. Thereafter, the procedure is ended.

The following description is made taking, as an example, the case of transmission of a UL signal from a general RS. The RS may be a mobile RS or a stationary RS. The BS, the RS and the MS operate in the same way as in FIGS. 5, 6 and 7 and thus their descriptions will be omitted for conciseness.

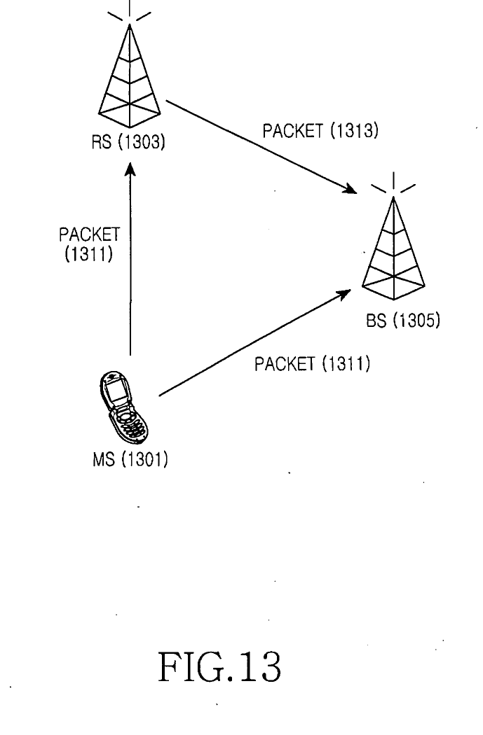

Referring to FIG. 13, an MS 1301 transmits UL signals to an RS 1303 and a BS 1305 (step 1311). Thereafter, RS 1303 transmits the received UL signal of MS 1301 to BS 1305 (step 1313).

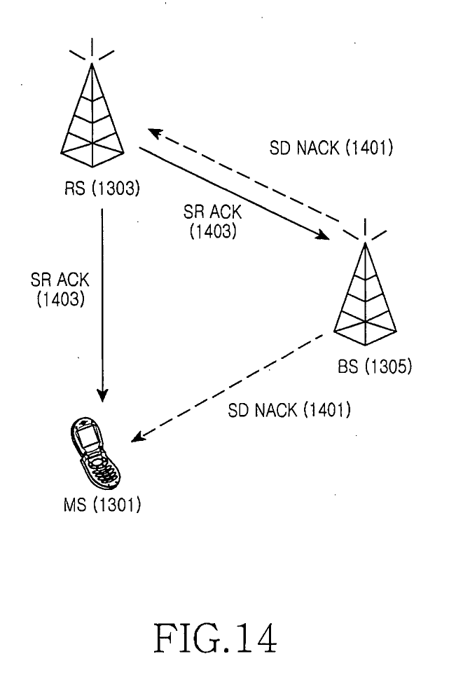

As illustrated in FIG. 14, BS 1305 and RS 1303 transmit a response signal for the UL signal received from MS 1301. If the received UL signal is decoded as “errorless”, the response signal is an ACK response signal; and if there is an error in the received UL signal, the response signal is a NACK response signal.

Referring to FIG. 14, upon receipt of the UL signal from MS 1301, BS 1305 and RS 1303 decode the received UL signal to determine if there is an error in the received UL signal. Depending on whether there is an error in the received UL signal, BS 1305 and RS 1303 transmit an ACK response signal or a NACK response signal to MS 1301.

That is, BS 1305 determines if there is an error in UL signals received from MS 1301 and RS 1303. If there is an error in the UL signals received from MS 1301 and RS 1303, BS 1305 transmits a NACK response signal to MS 1301 and RS 1303 (step 1401). On the other hand, if there is no error in the received UL signals, BS 1305 transmits an ACK response signal to MS 1301 and RS 1303.

In addition, RS 1303 determines if there is an error in the UL signal received from MS 1301. If there is an error in the received UL signal, RS 1303 transmits a NACK response signal to BS 1305 and MS 1301. On the other hand, if there is no error in the received UL signal, RS 1303 transmits an ACK response signal to BS 1305 and MS 1301 (step 1403).

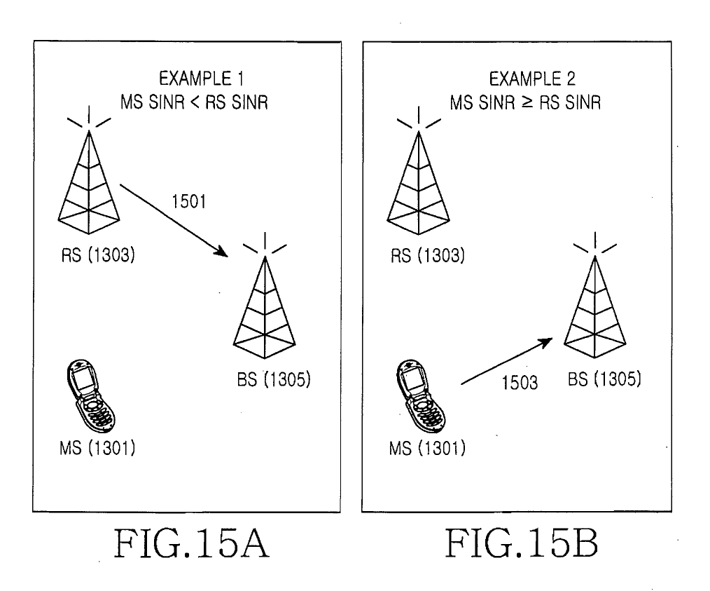

As described above, if there is an error in the received UL signal of MS 1301, BS 1305 transmits the NACK response signal to request retransmission of the UL signal of MS 1301. In this case, as illustrated in FIG. 15, BS 1305 detects the channel condition information (e.g., SINRs) of MS 1301 and RS 1303 to request retransmission of the UL signal over a channel with a good condition. The channel condition information is measured at MS 1301 and RS 1303 and is transmitted to BS 1305 over a UL channel.

The following description will be made on the assumption that RS 1303 has errorlessly received the UL signal of MS 1301.

Referring to FIGS. 15A and 15B, if there is an error in the UL signal received from MS 1301, BS 1305 compares the SINRs received from MS 1301 and RS 1303. Thereafter, BS 1305 requests MS 1301 (or the RS 1303) with a good channel condition to retransmit the erroneously received UL signal. The SINR of RS 1303 refers to an SINR of a link between RS 1303 and BS 1305, and the SINR of MS 1301 refers to an SINR of a link between MS 1301 and BS 1305.

That is, if the SINR of MS 1301 is less than the SINR of RS 1303 (MS SINR<RS SINR), BS 1305 requests RS 1303 to retransmit the erroneously-received UL signal of MS 1301, as illustrated in FIG. 15A. Upon receipt of the retransmission request from BS 1305, RS 1303 retransmits the erroneously received UL signal of MS 1301 to BS 1305 (step 1501).

On the other hand, if the SINR of MS 1301 is greater than or equal to the SINR of RS 1303 (MS SINR≧RS SINR), BS 1305 requests MS 1301 to retransmit the erroneously-received UL signal, as illustrated in FIG. 15B. Upon receipt of the retransmission request from BS 1305, MS 1301 retransmits the erroneously received UL signal to BS 1305 (step 1503).

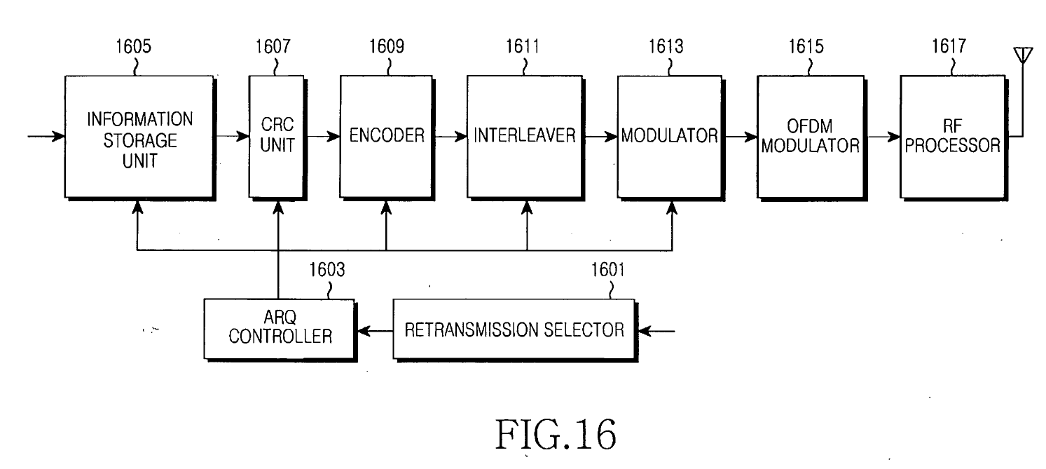

Referring to FIG. 16, the BS transmitter includes an antenna, a retransmission selector 1601, an ARQ controller 1603, an information storage unit 1605, a Cyclic Redundancy Check (CRC) unit 1607, an encoder 1609, an interleaver 1611, a modulator 1613, an OFDM modulator 1615, and an RF processor 1617.

Upon receipt of a retransmission request, retransmission selector 1601 detects the channel conditions of an RS, an MS and a BS to select a subject that is to retransmit the requested signal.

ARQ controller 1603 determines relevant information, such as a frame size, a modulation scheme and a coding rate, for retransmission of a signal to the selected subject and outputs the determined information to information storage unit 1605, CRC unit 1607, encoder 1609, interleaver 1611 and modulator 1613.

Information storage unit 1605 stores transmitted information for a predetermined period. Thereafter, if selected as the subject to retransmit a signal, information storage unit 1605 searches a previously transmitted information packet to reconstruct a frame under the control of ARQ controller 1603. CRC unit 1607 adds an error check code to the reconstructed frame.

Encoder 1609 encodes the retransmission signal at the coding rate provided by the ARQ controller 1603. Interleaver 1611 interleaves the encoded signal to be robust against a burst error.

Modulator 1613 modulates the interleaved signal in the modulation scheme provided by ARQ controller 1603.

OFDM modulator 1615 performs Inverse Fast Fourier Transform (IFFT) operation on the frequency-domain signal received from modulator 1613, thereby outputting a time-domain baseband signal.

The RF processor 1617 up converts the baseband signal received from the OFDM modulator 1615 into an RF signal, and transmits the RF signal through the antenna.

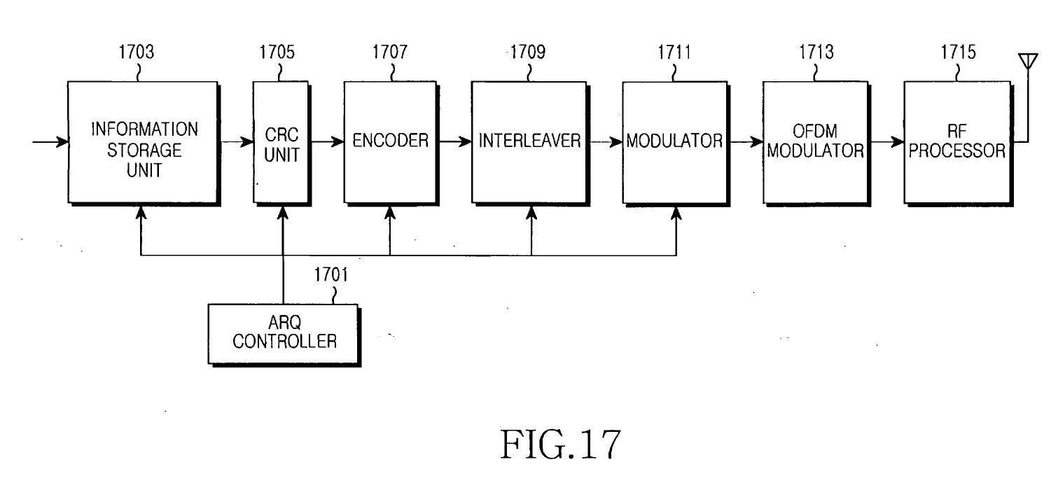

Referring to FIG. 17, the RS transmitter includes an antenna, an ARQ controller 1701, an information storage unit 1703, a CRC unit 1705, an encoder 1707, an interleaver 1709, a modulator 1711, an OFDM modulator 1713, and an RF processor 1715.

Upon receipt of a retransmission request signal from a BS, ARQ controller 1701 detects information, such as a destination, a frame size, a modulation scheme and a coding rate, for retransmission of a signal received from the BS, and outputs the detected information to information storage unit 1703, CRC unit 1705, encoder 1707, interleaver 1709 and modulator 1711.

Information storage unit 1605 stores transmitted information and information received from an MS, for a predetermined period. Thereafter, upon receipt of a retransmission signal from ARQ controller 1701, information storage unit 1703 searches a previously transmitted information packet and previously received MS RX signal information to reconstruct a frame. CRC unit 1705 adds an error check code to the reconstructed frame.

Encoder 1707 encodes the retransmission signal at the coding rate provided by ARQ controller 1701. Interleaver 1709 interleaves the encoded signal to be robust against a burst error.

Modulator 1711 modulates the interleaved signal in the modulation scheme provided by ARQ controller 1701.

OFDM modulator 1713 performs an IFFT operation on the frequency-domain signal received from modulator 1711, thereby outputting a time-domain baseband signal.

RF processor 1715 up converts the baseband signal received from OFDM modulator 1713 into an RF signal, and transmits the RF signal through the antenna.

As described above, the present invention performs an ARQ operation in the multi-hop relay cellular network in accordance with the channel conditions of a BS, an RS and an MS, thereby making it possible to increase the reliability of communication between the BS, the RS and the MS.

While the invention has been shown and described with reference to certain preferred embodiments thereof, it will be understood by those skilled in the art that various changes in form and details may be made therein without departing from the spirit and scope of the invention as further defined by the appended claims.

What is claimed is:

1. A method for performing an automatic repeat request (ARQ) operation of a base station (BS) in a cellular network, the method comprising the steps of:
determining if there is an error in a received uplink (UL) signal upon receipt of the uplink (UL) signal from a mobile station (MS);
comparing a channel condition for a relay station (RS) with a channel condition for the MS if there is the error in the received UL signal;
determining if the RS knows the erroneously received UL signal if the channel condition for the RS is better than the channel condition for the MS; and
requesting the RS to retransmit the erroneously received UL signal if the RS knows the erroneously received UL signal.

2. The method of claim 1, further comprising the step of transmitting an ACK response message to the MS and the RS if there is no error in the received UL signal.

3. The method of claim 1, further comprising the step of transmitting a NACK response message to the MS and the RS if there is an error in the received UL signal.

4. The method of claim 1, wherein the channel condition is expressed as signal-to-interference plus noise ratio (SINR).

5. The method of claim 1, further comprising the step of requesting the MS to retransmit the erroneously received UL signal if the channel condition for the MS is better than the channel condition for the RS.

6. The method of claim 1, wherein the step of determining if the RS knows the erroneously-received UL signal comprises the steps of:
determining if a response message is received after receipt of the erroneously received UL signal by the RS;
determining that the RS knows the erroneously received UL signal if the received response message is an ACK response message; and
determining that the RS does not know the erroneously received UL signal if the received response message is a NACK response message.

7. The method of claim 1, further comprising the step of requesting the MS to retransmit the erroneously received UL signal if the RS does not know the erroneously received UL signal.

8. The method of claim 1, wherein the RS is one of a mobile RS, a stationary RS, and an MS functioning as an RS.

9. A method for performing an automatic repeat request (ARQ) operation of a relay station (RS) in a cellular network, the method comprising the steps of:
determining if there is an error in the received UL signal upon receipt of an uplink (UL) signal from a mobile station (MS);
transmitting an ACK response message to the MS and a base station (BS) if there is no error in the received UL signal; and
selecting a retransmission signal according to the request signal and transmitting the selected retransmission signal to the BS if a retransmission request signal is received from the BS.

10. The method of claim 9, further comprising the step of transmitting a NACK response message to the MS and the BS if there is an error in the received UL signal.

11. The method of claim 9, further comprising the step of transmitting channel condition information for the MS to the BS.

12. The method of claim 9, wherein the RS is one of a mobile RS, a stationary RS, and an MS functioning as an RS.

13. A method for performing an automatic repeat request (ARQ) operation of a mobile station (MS) in a cellular network, the method comprising the steps of:
determining if a response signal for the UL signal is received after transmission of an uplink (UL) signal to a base station (BS) and a relay station (RS);
determining if a retransmission request signal for the UL signal is received from the BS when a NACK response signal is received from the BS; and
selecting a retransmission signal according to the request and transmitting the selected retransmission signal to the BS if the retransmission request signal is received.

14. The method of claim 13, further comprising the step of transmitting channel condition information for the MS to the BS.

15. A method for performing an automatic repeat request (ARQ) operation of a base station (BS) in a cellular network, the method comprising the steps of:
determining if a response message is received from the MS and the RS that has received the DL signal after transmission of a downlink (DL) signal to a mobile station (MS) and a relay station (RS);
comparing the channel condition of a link between the RS and the MS with the channel condition of a link between the BS and the MS if the received response message is a NACK response message;
determining if the RS knows the erroneously received DL signal if the link between the RS and the MS is better in channel condition than the link between the BS and the MS; and
requesting the RS to retransmit the erroneously received DL signal to the MS if the RS knows the erroneously received DL signal.

16. The method of claim 15, wherein the channel condition is expressed as signal-to-interference plus noise ratio (SINR).

17. The method of claim 15, further comprising the step of retransmitting the erroneously received DL signal to the MS if the link between the BS and the MS is better in channel condition than the link between the RS and the MS.

18. The method of claim 15, wherein the step of determining if the RS knows the erroneously received DL signal comprises:
determining if a response message is received after receipt of the erroneously received DL signal by the RS;
determining that the RS knows the erroneously received DL signal if the received response message is an ACK response message; and
determining that the RS does not know the erroneously received DL signal if the received response message is a NACK response message.

19. The method of claim 15, further comprising the step of transmitting the erroneously received DL signal to the MS if the RS does not know the erroneously received DL signal.

20. The method of claim 15, wherein the RS is one of a mobile RS, a stationary RS, and an MS functioning as an RS.

21. A method for performing an automatic repeat request (ARQ) operation of a relay station (RS) in a cellular network, the method comprising the steps of:
upon receipt of a downlink (DL) signal from a base station (BS), determining if there is an error in the received DL signal;
transmitting an ACK response message to the BS and a mobile station (MS) if there is no error in the received DL signal; and
retransmitting a retransmission signal corresponding to the retransmission request signal to the MS if a retransmission request signal is received from the BS.

22. The method of claim 21, further comprising transmitting a NACK response message to the BS and the MS if there is an error in the received DL signal.

23. The method of claim 21, further comprising transmitting channel condition information for the MS to the BS.

24. The method of claim 21, wherein the RS is one of a mobile RS, a stationary RS, and an MS functioning as an RS.

25. A base station (BS) transmitter for performing an automatic repeat request (ARQ) operation in a cellular network comprising:
a retransmission selector for detecting the channel conditions of a relay station (RS), a mobile station (MS) and a base station (BS) to select which among them is to retransmit a signal; and
an ARQ controller for determining a coding rate, a modulation scheme and a frame size of the retransmission signal.

26. The BS transmitter of claim 25, wherein the retransmission selector compares the channel condition information for the MS with the channel condition information for the RS to select a good channel with respect to an uplink (UL) signal, and compares the channel condition information of a link between the BS and the MS with the channel condition information of a link between the RS and the MS to select a good channel with respect to a downlink (DL) signal.

27. The BS transmitter of claim 25, wherein the channel condition is expresses as signal-to-interference plus noise ratio (SINR).

28. The BS transmitter of claim 25, further comprising:
an information storage unit for searching a retransmission signal to reconstruct a frame under the control of the ARQ controller;
an error check unit for inserting an error check code into the reconstructed frame;
an encoder for encoding an output signal of the error check unit at the coding rate determined by the ARQ controller;
an interleaver for interleaving the encoded signal under the control of the ARQ controller; and
a modulator for modulating the interleaved signal in the modulation scheme determined by the ARQ controller.
